(19) United States
(12) Patent Application Publication
(10) Pub. No.: US 2016/0239162 A1
(43) Pub. Date: Aug. 18, 2016

(54) System and Method for Determining Distances Among User Interface Elements

(71) Applicant: HCL Technologies Ltd., Noida U.P. (IN)

(72) Inventors: Geetha Natarajan Sivasubramanian, Hyderabad (IN); Krishna Rao Vatturi Veera Venkata, Redmond, WA (US); Lakshmi Narayana Gajjalakonda, Hyderabad (IN)

(21) Appl. No.: 14/623,048

(22) Filed: Feb. 16, 2015

(51) Int. Cl. G06F 3/0482; G06F 3/0484

(52) U.S. Cl. CPC G06F 3/0482; G06F 3/0484

(57) ABSTRACT

Disclosed is a system for determining distance between two or more user UI elements present on a GUI. A UI element extraction module extracts a plurality of UI elements from the GUI. A margin determination module derives a left margin of the GUI based on a position of a first UI element of the plurality of elements. A logical block creation module creates a plurality of logical blocks comprising the plurality of UI elements. A logical block, of the plurality of logical blocks, is created based upon a UI element lying on the left margin. A neighboring UI element identification module identifies one or more neighboring UI elements of at least one UI element present in the same or adjacent logical block. A distance computation module computes distance between the at least one UI element and each neighboring UI element. A distance displaying module creates a reference UI element for displaying the distance.

### TECHNICAL FIELD

The present subject matter described herein, in general, relates to, a Graphical User Interface (GUI) of a software application, and more particularly relates to system and method for determining distance between User Interface (UI) elements present on the GUI.

### BACKGROUND

Typically User Interface (UI) of a software application is designed by a software developer based on requirements provided in order to design a page layout of the software application. The requirements may include an appropriate distance between a pair of UI elements, position of each UI element, font color, font size, and margins etc. Example of the UI elements may include, but not limited to, a heading, an image, a label, and a text box. Since the distance between the pair of UI elements should comply with the requirements, the software tester validates the UI, by verifying whether the distance between the pair of UI elements is complied, before deploying the software application in a production environment.

Though, there has been effort made in past to devise a computational systems capable of determining distances between elements on the GUI, however these computational systems fail to compute the distance for all the elements present on the GUI concurrently/simultaneously. Specifically, these computational systems enable calculating distance between neighboring elements. Further, in some of the computational systems, a specified portion/region on the GUI is captured based upon a user input, wherein the GUI elements falling within this region are selected for computing distance amongst them. Therefore, these conventional computational systems have to be iteratively executed until the distance between each element and each other element is determined. Such iterative process may lead to computational overhead, thereby resulting in overall increase in the computational time of the computing device.

### SUMMARY

Before the present systems and methods, are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application. This summary is provided to introduce concepts related to systems and methods for determining distance between two or more user interface (UI) elements and the concepts are further described below in the detailed description. This summary is not intended to identify essential features of the claimed subject matter nor is it intended for use in determining or limiting the scope of the claimed subject matter.

In one implementation, a system for determining distance between two or more user interface (UI) elements present on a Graphical User Interface (GUI) is disclosed. In one aspect, the system may comprise a processor and a memory coupled to the processor. The processor may execute a plurality of modules present in the memory. The plurality of modules may comprise a UI element extraction module, a margin determination module, a logical block creation module, a neighboring UI element identification module, a distance computation module, and a distance displaying module. The UI element extraction module may extract a plurality of UI elements from a Graphical User Interface (GUI). The margin determination module may derive a left margin of the GUI based on a position of a first UI element, of the plurality of elements, on the GUI. The logical block creation module may create a plurality of logical blocks comprising the plurality of UI elements. In one aspect, a logical block, of the plurality of logical blocks, is created based upon a UI element lying on the left margin. In one aspect, the logical block may comprise a subset of the plurality of UI elements. It may be understood that the subset includes the UI element. The neighboring UI element identification module may identify one or more neighboring UI elements of at least one UI element present in the same logical block. Then, it may identify one or more neighboring UI elements in the adjacent logical block for each visible UI element in previous logical block. After identifying the one or more neighboring UI elements, the distance between the one or more neighboring UI elements corresponding to each UI element is computed. After computing the distance, the distance is displayed on a reference UI element created between the one or more neighboring UI elements and each UI element.

In another implementation, a method for determining distance between two or more user interface (UI) elements present on a Graphical User Interface (GUI) is disclosed. In one aspect, in order to determine the distance, initially, a plurality of UI elements may be extracted from a Graphical User Interface (GUI). Upon extracting, a left margin of the GUI may be derived based on a position of a first UI element, of the plurality of elements, on the GUI. Once the left margin is derived, a plurality of logical blocks may be created. In one aspect, the plurality of logical blocks may comprise the plurality of UI elements. In one aspect, a logical block, of the plurality of logical blocks, is created based upon a UI element lying on the left margin. In one aspect, the logical block comprises a subset of the plurality of UI elements. It may be understood that the subset includes the UI element. Subsequent to the creation of the plurality of logical blocks, one or more neighboring UI elements of at least one UI element present in the same or adjacent logical block may be identified. After identifying the one or more neighboring UI elements, distance between the at least one UI element and each neighboring UI element may be computed. Upon computing the distance, a reference UI element may be created between the at least one UI element and each neighboring UI element in order to display the distance. In one aspect, the aforementioned method for determining the distance between the two or more user interface (UI) elements is performed by a processor using programmed instructions stored in a memory.

In yet another implementation, non-transitory computer readable medium embodying a program executable in a computing device for determining distance between two or more user interface (UI) elements present on a Graphical User Interface (GUI) is disclosed. The program may comprise a program code for extracting a plurality of UI elements from a Graphical User Interface (GUI). The program may comprise a program code for deriving a left margin of the GUI based on a position of a first UI element, of the plurality of elements, on the GUI. The program may comprise a program code for creating a plurality of logical blocks comprising the plurality of UI elements. In one aspect, a logical block, of the plurality of logical blocks, is created based upon a UI element lying on the left margin. In one aspect, the logical block may comprise a subset of the plurality of UI elements. It may be understood that the subset includes the UI element. The program may comprise a program code for identifying one or more neighboring UI elements of at least one UI element present in the same or adjacent logical block. The program may comprise a program code for computing distance between the at least one UI element and each neighboring UI element. The program may comprise a program code for creating a reference UI element between the at least one UI element and each neighboring UI element, wherein the reference UI element is created to display the distance.

### BRIEF DESCRIPTION OF THE DRAWINGS

The foregoing detailed description of embodiments is better understood when read in conjunction with the appended drawings. For the purpose of illustrating the disclosure, example constructions of the disclosure is shown in the present document; however, the disclosure is not limited to the specific methods and apparatus disclosed in the document and the drawings.

The detailed description is given with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for determining distance between two or more user interface (UI) elements present on a Graphical User Interface (GUI), in accordance with an embodiment of the present subject matter.

FIG. 2 illustrates the system, in accordance with an embodiment of the present subject matter.

FIGS. 3 to 6 are working examples of the system, in accordance with one or more embodiments of the present subject matter.

FIG. 7 illustrates a method for determining the distance between the two or more UI elements present on the GUI, in accordance with an embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

The present subject matter provides systems and methods for determining distance between two or more user interface (UI) elements present on a Graphical User Interface (GUI). In one aspect, the systems and methods facilitate to reduce testing effort of a software tester responsible for validating the distance, amongst the two or more user interface UI elements, against a pre-defined reference distance between the two or more user interface UI elements; even a software developer can use this to verify it. In order to determine the distance, a plurality of UI elements may be extracted from the GUI. The GUI may include, but not limited to, a web-page of a software application where the plurality of UI elements are located at distinct coordinates of the web-page. Examples of the plurality of UI elements may include, but not limited to, a heading, an image, a video, a text, a label, and a text box.

In one embodiment, a left margin for the GUI may be derived based upon the position of the first element of the plurality of elements. It may be noted that in some embodiments, at least few of the UI elements may not be visible on the web-page. In one aspect, the dimension of these few elements is 0, and hence identified as invisible elements. In one embodiment, the invisible elements may be filtered out for subsequent processing of computation of the distance. Upon filtering, a plurality of logical blocks may be created, wherein each logical block may comprise a subset of the plurality of UI elements. Once the plurality of logical blocks are created, one or more neighboring UI elements corresponding to each UI element of the subset, present in a logical block of the plurality of blocks, are identified in at least one location. In one aspect, the one or more neighboring UI elements may be located on top, bottom, right, or left of each of the one or more neighboring UI elements.

After identifying the one or more neighboring UI elements, the distance between the one or more neighboring UI elements corresponding to each UI element is computed. After computing the distance, the distance is displayed on a reference UI element created between the one or more neighboring UI elements and each UI element. In one aspect, the reference UI element is an edge created between the one or more neighboring UI elements and each UI element. In some embodiment, the reference element is a Hyper Text Markup Language (HTML) component. Thus, in this manner, the distance between the two or more UI elements present on the GUI is determined to assist the software developer or the software tester for validating the distance against the pre-defined reference distance thereby ensuring that the requirements provided are complied before deploying the software application in a production environment.

While aspects of described system and method determining distance between two or more user interface (UI) elements and may be implemented in any number of different computing systems, environments, and/or configurations, the embodiments are described in the context of the following exemplary system.

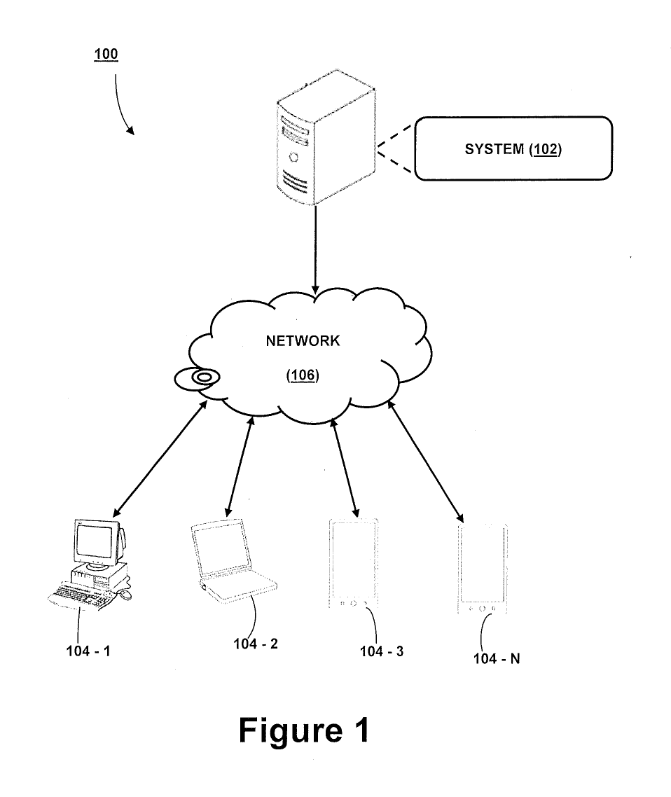

Referring now to FIG. 1, a network implementation 100 of a system 102 for determining distance between two or more user interface (UI) elements present on a Graphical User Interface (GUI). In one aspect, the system 102 extracts a plurality of UI elements from a Graphical User Interface (GUI). Upon extracting, the system 102 derives a left margin of the GUI based on a position of a first UI element, of the plurality of elements, on the GUI. Once the left margin is derived, the system 102 creates a plurality of logical blocks. In one aspect, the plurality of logical blocks comprises the plurality of UI elements. In one aspect, a logical block, of the plurality of logical blocks, is created based upon a UI element lying on the left margin. In one aspect, the logical block comprises a subset of the plurality of UI elements. It may be understood that the subset includes the UI element. Subsequent to the creation of the plurality of logical blocks, the system 102 identifies one or more neighboring UI elements of at least one UI element present in the logical block. After identifying the one or more neighboring UI elements, the system 102 computes distance between the at least one UI element and each neighboring UI element. Upon computing the distance, the system 102 displays the distance on a reference UI element created between the at least one UI element and each neighboring UI element.

In one embodiment, the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, a cloud-based computing environment and the like. In one implementation, the system 102 may comprise the cloud-based computing environment in which the user may operate individual computing systems configured to execute remotely located applications. In another embodiment, the system 102 may also be implemented on a client device hereinafter referred to as a user device. It may be understood that the system implemented on the client device supports a plurality of browsers and all viewports. Examples of the plurality of browsers may include, but not limited to, Chrome™, Mozilla™, Internet Explorer™, Safari™, and Opera™. It will be understood that the system 102 may be accessed by multiple users through one or more user devices 104-1, 104-2, 104-3, 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the intemet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

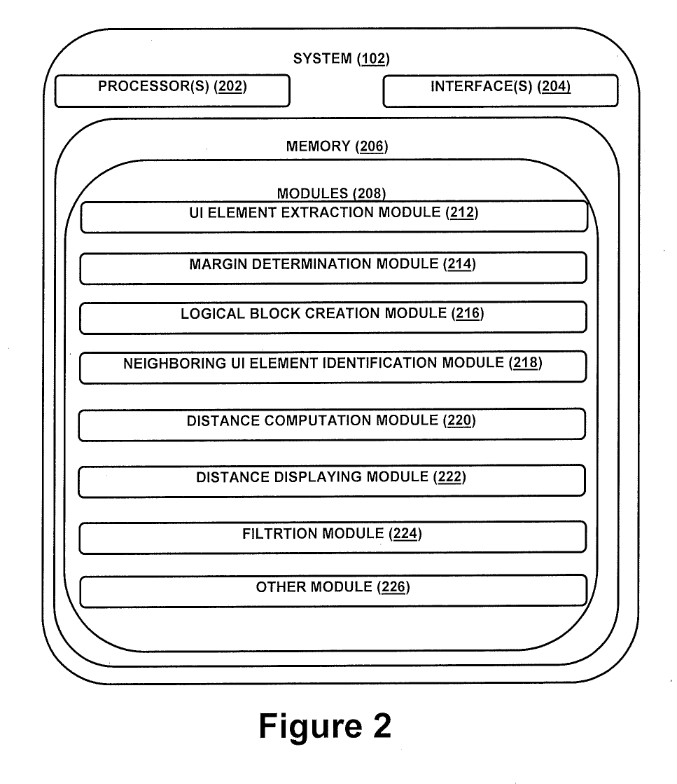

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a UI element extraction module 212, a margin determination module 214, a logical block creation module 216, a neighboring UI element identification module 218, a distance computation module 220, a distance displaying module 222, a filtration module 224, and other modules 226. The other modules 226 may include programs or coded instructions that supplement applications and functions of the system 102. The modules 208 described herein may be implemented as software modules that may be executed in the cloud-based computing environment of the system 102.

The memory 206, amongst other things, serves as a repository for storing data processed, received, and generated by one or more of the modules 208. The memory 206 may include data generated as a result of the execution of one or more modules in the other module 226.

In one implementation, at first, a user may use the client device 104 to access the system 102 via the I/O interface 204. The user may register them using the I/O interface 204 in order to use the system 102. In one aspect, the user may access the I/O interface 204 of the system 102 for determining distance between two or more user interface (UI) elements present on a Graphical User Interface (GUI). In order to determine the distance, the system 102 may employ the UI element extraction module 212, the margin determination module 214, the logical block creation module 216, the neighboring UI element identification module 218, the distance computation module 220, the distance displaying module 222, and the filtration module 224.

Further referring to FIG. 2, it may be understood that the GUI may comprise a plurality of UI elements. In one example the GUI may be a web-page that may comprise the plurality of UI elements positioned at a specific coordinates of the web-page. In some embodiments, the plurality of GUI elements is developed using a Hyper Text Markup Language (HTML). Examples of the plurality of UI elements may include, but not limited to, a header, an image, a video, a text, a label, and a text box. In order to comply with design requirements, specifically vis-à-vis the distance between the two or more user interface (UI) elements, provided for the layout of the web-page, the UI element extraction module 212 extracts the plurality of plurality of UI elements from the GUI hereinafter referred to as the web-page for understanding the method for determining the distance.

In one aspect, some of the UI elements hereinafter referred to as invisible UI elements that may not be visible on the web-page when the web-page is rendered on a browser. In one aspect, the invisible UI elements indicate a subset of elements of the plurality of UI elements having dimension ‘0’. Once the invisible UI elements are encountered while extracting the plurality of UI elements, the filtration module 224 may filter the invisible UI elements from the plurality of UI elements thereby leaving only visible UI elements for further processing. In one aspect, the visible UI elements indicate another subset of the elements of the plurality of UI elements having dimension greater than ‘0’.

Once the invisible UI elements are filtered, the margin determination module 214 may derive a left margin of the web-page. In one aspect, the left margin may be derived based on a position of a first visible UI element, of the visible UI elements, present on the web-page. The left margin is a reference indicating that the distance is calculated amongst the two or more visible UI elements that appear after the left margin of the web-page. Once the left margin is derived, the logical block creation module 216 creates a plurality of logical blocks comprising the visible UI elements. It may be understood that a logical block, of the plurality of logical blocks, is created based upon a visible UI element lying on the left margin. In one aspect, the logical block comprises a subset of the visible UI elements, wherein the subset includes the visible UI element.

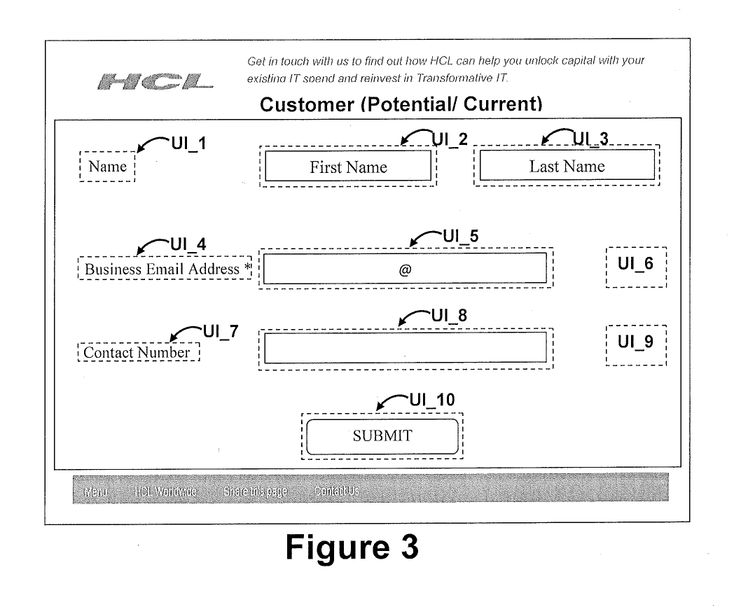

In order to understand functioning of the UI element extraction module 212, the margin determination module 214, the logical block creation module 216, and the filtration module 224, consider an example where a web-page comprises a plurality of UI elements. As illustrated in FIG. 3, it is observed that the web-page comprises 10 UI elements positioned at distinct coordinates of the web-page. In one aspect, 10 UI elements are referred by UI_1, UI_2, UI_3, UI_4, UI_5, UI_6, UI_7, UI_8, UI_9, and UI_10, where UI_1 being a first UI element whereas UI 10 being a last UI element present on the web-page. Initially, 10 UI elements are extracted from the web-page by the UI element extraction module 212. The highlighted edges around each of 10 UI elements indicate that UI_1, UI_2, UI_3, UI_4, UI_5, UI_6, UI_7, UI_8, UI_9, and UI_10 are read and extracted from the web-page by the UI element extraction module 212.

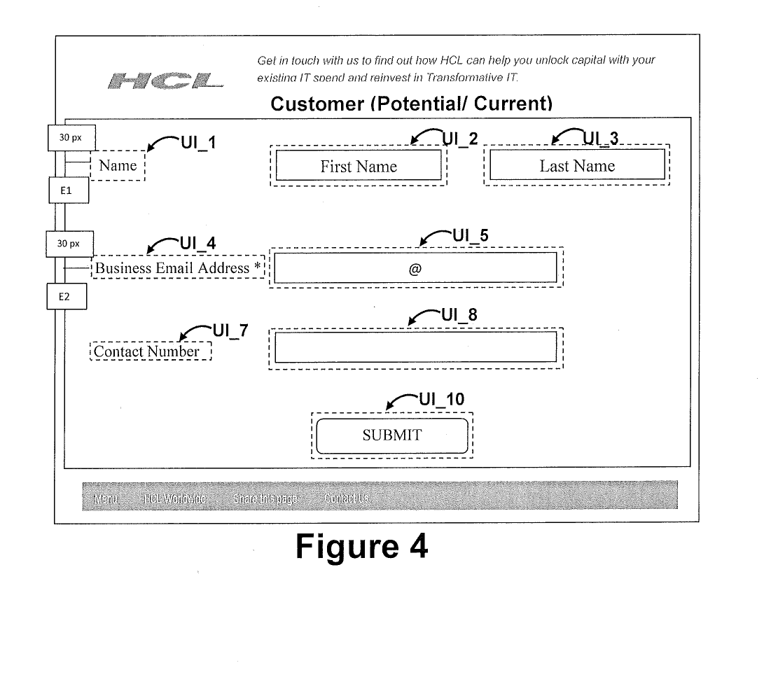

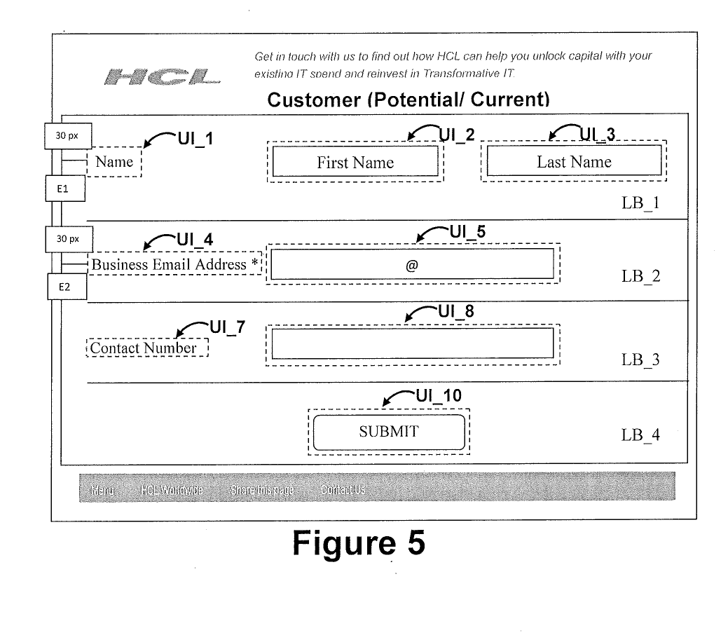

Upon extracting the 10 UI elements, it may be understood that UI_6 and UI_9 are invisible due to dimensions corresponding to UI_6 and UI_9 are ‘0’. Therefore UI_6 and UI_9 are invisible when the web-page is rendered on the browser. Due to the invisibility, the filtration module 224 filters UI_6 and UI 9 from the plurality of UI elements and thereby leaving UI_1, UI_2, UI_3, UI_4, UI_5, UI_7, UI_8, and UI_10 for further processing. Once UI_6 and UI_9 are filtered, the margin determination module 214 derives a left margin on the web-page as shown in FIG. 4. Since UI_1 is the first UI element, the margin determination module 214 derives the left margin of the web-page based on the position of UI_1. Once the left margin is derived, the logical block creation module 216 creates 4 logical blocks LB_1, LB_2, LB_3, and LB_4 as shown in FIG. 5, wherein the creation of the logical blocks is based upon the left margin derived and the UI elements lying on the left margin. In this example, the logical block LB_1 comprises UI_1, UI_2, and UI_3. LB_2 comprises UI_4 and UI_5. LB_3 comprises UI_7. LB_4 comprises UI_10. Thus, in this manner, the plurality of logical blocks may be created.

Subsequent to the creation of the plurality of logical blocks, the neighboring UI element identification module 218 may identify one or more neighboring UI elements of at least one visible UI element present in the logical block. The one or more neighboring UI elements may be identified in at least one lodation such as top, bottom, right, and left based on X and Y coordinates. In one aspect, the neighboring UI element identification module 218 stores location, corresponding to each neighboring UI element identified for each UI element, in the memory 206. Then, the neighboring UI element identification module 218 may identify one or more neighboring UI elements in adjacent logical block for all visible UI element present in the previous logical block. In one aspect, the neighboring UI element identification module 218 stores location, corresponding to each neighboring UI element identified from adjacent logical block.

Subsequent to the identification of the one or more neighboring UI elements, the distance computation module 220 computes distance between the at least one visible UI element and each neighboring UI element. In one aspect, unit of the distance computed between the at least one visible UI element and each neighboring UI element may be in pixels, centimeters, and meters etc. Upon computation of the distance, the distance displaying module 222 may create a reference UI element between the at least one visible UI element and each neighboring UI element. The reference UI element is created to display the distance. In one aspect, the reference UI element may be an edge created between the at least one visible UI element and each neighboring UI element. In one embodiment, the edge represents an HTML component and may be uniquely identified with a distinct color.

In one embodiment, the distance displaying module 222 may draw either a horizontal edge or a vertical edge between the at least one visible UI element and each neighboring UI element. Once the horizontal edge or the vertical edge is drawn, the distance displaying module 222 displays the distance on the horizontal edge or the vertical edge. It may be understood that the edge is a Hypertext Mark up Language (HTML) element created dynamically in between the at least one visible UI element and each neighboring UI element.

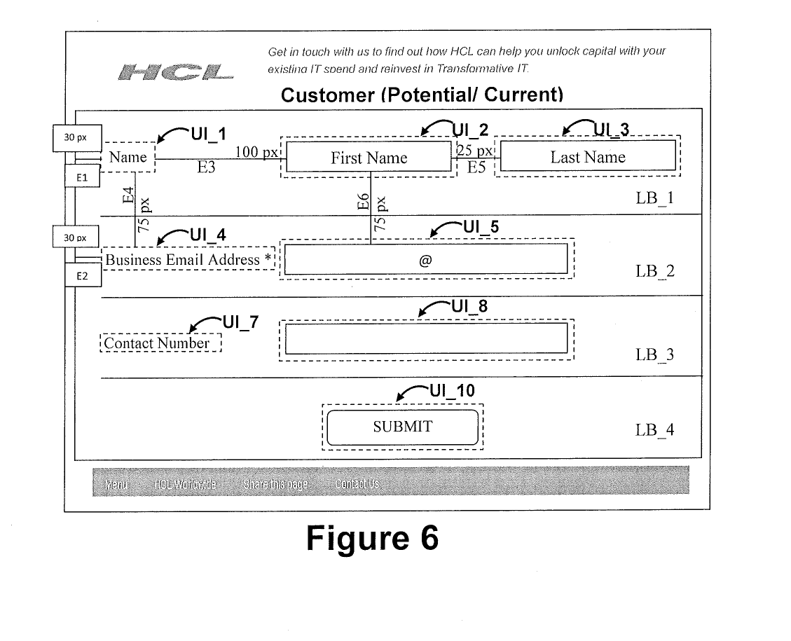

In order to understand functioning of the neighboring UI element identification module 218, the distance computation module 220, the distance displaying module 222, consider the example, same as aforementioned, where 4 logical blocks i.e. LB_1, LB_2, LB_3 and LB_4 comprises UI elements (UI_1, UI_2, and UI_3), (UI_4 and UI_5), (UI_7 and UI_8), and (UI_10) respectively. As shown in FIG. 6, the neighboring UI element identification module 218 identifies neighboring UI elements corresponding to each of UI_1, UI_2, UI_3, UI_4, UI_4, UI_5, UI_7, UI_8, and UI_10. Further referring to the FIG. 6, it may be understood that UI_2 and UI_4 are the neighboring UI elements corresponding to UI_1. Similarly, UI_1, UI_3, and UI _5 are the neighboring UI elements corresponding to UI_2. Likewise, the neighboring UI element identification module 218 identifies the one or more neighboring UI elements of the at least one visible UI element present in the same or adjacent logical block.

As UI_1 is the first element in the logical block and doesn't have any UI element in left position, the distance computation module 220 computers the distance between UI_1 and left border of the page and the distance displaying module 222 dynamically creates edge between them i.e. El and thereby displays the distance on E1. Similarly, the distance between UI_4 and left border of the page is computed and displayed as E2. Then, since UI_2 and UI_4 are the neighboring UI elements corresponding to UI_1, the distance computation module 220 computes the distance between (UI_2, UI_1) and (UI_4, UI_1) as shown in the FIG. 6. Similarly the distance computation module 220 computes the distance (UI_3, UI_2), and (UI_5, UI_2). Subsequent to the computation of the distance, the distance displaying module 222 dynamically creates edges (reference UI elements) i.e. E3, E4, E5, and E6 between the (UI_2, UI_1), (UI_4, UI_1), (UI_3, UI_2), and (UI_5, UI_2) respectively and thereby display the distance on E3, E4, E5, and E6.

Thus, in this manner, the distance may be determined between two or more user interface (UI) elements, present on the GUI, and displayed to a software developer or a software tester. In one aspect, the distance displayed may assist the software developer or tester to validate the distance with the rep-defined reference distance thereby ensuring that the design requirements provided are complied before deploying a software application in a production environment.

Exemplary embodiments discussed above may provide certain advantages. Though not required to practice aspects of the disclosure, these advantages may include those provided by the following features.

Some embodiments enable a system and a method to validate distance, between two or more user interface (UI) elements, against a pre-defined reference distance accurately without manual intervention.

Some embodiments enable a system and a method to reduce testing effort for validating the distance between the two or more UI elements.

Some embodiments enable a system and a method to increase accuracy to achieve consistent look and feel, readability, and usability.

Some embodiments enable a system and a method is a cost-effective approach for ensuring the design requirements provided are complied before deploying a software application in a production environment.

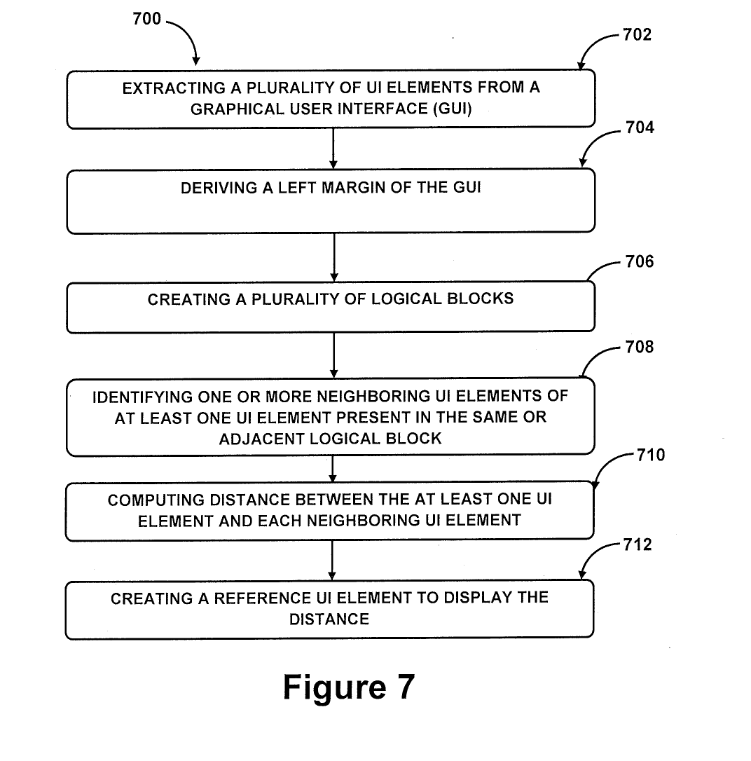

Referring now to FIG. 7, a method 700 for determining distance between two or more user interface (UI) elements present on a Graphical User Interface (GUI) is shown, in accordance with an embodiment of the present subject matter. The method 700 may be described in the general context of computer executable instructions. Generally, computer executable instructions can include routines, programs, objects, components, data structures, procedures, modules, functions, etc., that perform particular functions or implement particular abstract data types. The method 700 may also be practiced in a distributed computing environment where functions are performed by remote processing devices that are linked through a communications network. In a distributed computing environment, computer executable instructions may be located in both local and remote computer storage media, including memory storage devices.

The order in which the method 700 is described is not intended to be construed as a limitation, and any number of the described method blocks can be combined in any order to implement the method 700 or alternate methods. Additionally, individual blocks may be deleted from the method 700 without departing from the spirit and scope of the subject matter described herein. Furthermore, the method can be implemented in any suitable hardware, software, firmware, or combination thereof However, for ease of explanation, in the embodiments described below, the method 700 may be considered to be implemented as described in the system 102.

At block 702, a plurality of UI elements from a Graphical User Interface (GUI) may be extracted. In one implementation, the plurality of UI elements may be extracted by the UI element extraction module 212.

At block 704, a left margin of the GUI may be derived based on a position of a first UI element, of the plurality of elements, on the GUI. In one implementation, the left margin of the GUI may be derived by the margin determination module 214.

At block 706, a plurality of logical blocks comprising the plurality of UI elements may be created. In one aspect, a logical block, of the plurality of logical blocks, may be created based upon a UI element lying on the left margin. In one aspect, the logical block may comprise a subset of the plurality of UI elements and the subset includes the UI element, In one implementation, the plurality of logical blocks may be created by the logical block creation module 216.

At block 708, one or more neighboring UI elements of at least one UI element, present in the logical block, may be identified. In one implementation, one or more neighboring UI elements may be identified by the neighboring UI element identification module 218.

At block 710, distance between the at least one UI element and each neighboring UI element may be computed. In one implementation, the distance may be computed by the distance computation module 220.

At block 712, a reference UI element between the at least one UI element and each neighboring UI element may be for created. In one aspect, the reference UI element may be created to display the distance. In one implementation, the reference UI element may be created by the distance displaying module 222.

Although implementations for methods and systems for determining distance between two or more user interface (UI) elements have been described in language specific to structural features and/or methods, it is to be understood that the appended claims are not necessarily limited to the specific features or methods described. Rather, the specific features and methods are disclosed as examples of implementations for determining the distance.

We claim:

1. A method for determining distance between two or more user interface (UI) elements present on a Graphical User Interface (GUI), the method comprising:
extracting, by a processor, a plurality of UI elements from a Graphical User Interface (GUI);
deriving, by the processor, a left margin of the GUI based on a position of a first UI element, of the plurality of elements, on the GUI;
creating, by the processor, a plurality of logical blocks comprising the plurality of UI elements, wherein a logical block, of the plurality of logical blocks, is created based upon a UI element lying on the left margin, and wherein the logical block comprises a subset of the plurality of UI elements, and wherein the subset includes the UI element;
identifying, by the processor, one or more neighboring UI elements of at least one UI element present in the logical block;
computing, by the processor, distance between the at least one UI element and each neighboring UI element; and
creating, by the processor, a reference UI element between the at least one UI element and each neighboring UI element, wherein the reference UI element is created to display the distance.

2. The method of claim 1, wherein the plurality of UI elements comprises a heading, an image, a video, a text, a label, and a text box.

3. The method of claim 1 further comprising filtering one or more UI elements from the plurality of UI elements based on one or more parameters comprising dimension, visibility associated to each UI control.

4. The method of claim 1, wherein the one or more neighboring UI elements are identified in at least one location comprising a top, a bottom, a right, and a left.

5. The method of claim 1, wherein the reference UI element is an edge created between the at least one UI element and each neighboring UI element.

6. A system for determining distance between two or more user interface (UI) elements present on a Graphical User Interface (GUI), the system comprising:
a processor; and
a memory coupled to the processor, wherein the processor is capable of executing a plurality of modules stored in the memory, and wherein the plurality of module comprising:
a UI element extraction module for extracting a plurality of UI elements from a Graphical User Interface (GUI);
a margin determination module for deriving a left margin of the GUI based on a position of a first UI element, of the plurality of elements, on the GUI;
a logical block creation module for creating a plurality of logical blocks comprising the plurality of UI elements, wherein a logical block, of the plurality of logical blocks, is created based upon a UI element lying on the left margin, and wherein the logical block comprises a subset of the plurality of UI elements, and wherein the subset includes the UI element;
a neighboring UI element identification module for identifying one or more neighboring UI elements of at least one UI element present in the logical block;
a distance computation module for computing distance between the at least one UI element and each neighboring UI element; and
a distance displaying module for creating a reference UI element between the at least one UI element and each neighboring UI element, wherein the reference UI element is created to display the distance.

7. The system of claim 6 further comprising a filtration module for filtering one or more UI elements from the plurality of UI elements, wherein the one or more UI elements are filtered based on one or more parameters comprising dimension, visibility associated to each UI control.

8. The system of claim 6, wherein the reference UI element is an edge created between the at least one UI element and each neighboring UI element, and wherein the distance displaying module displays the distance on the edge.

9. A non-transitory computer readable medium embodying a program executable in a computing device for determining distance between two or more user interface (UI) elements present on a Graphical User Interface (GUI), the program comprising a program code comprising:
a program code for extracting a plurality of UI elements from a Graphical User Interface (GUI);
a program code for deriving a left margin of the GUI based on a position of a first UI element, of the plurality of elements, on the GUI;
a program code for creating a plurality of logical blocks comprising the plurality of UI elements, wherein a logical block, of the plurality of logical blocks, is created based upon a UI element lying on the left margin, and wherein the logical block comprises a subset of the plurality of UI elements, and wherein the subset includes the UI element;
a program code for identifying one or more neighboring UI elements of at least one UI element present in the logical block;
a program code for computing distance between the at least one UI element and each neighboring UI element; and
a program code for creating a reference UI element between the at least one UI element and each neighboring UI element, wherein the reference UI element is created to display the distance.
